(19) United States
(12) Patent Application Publication
(10) Pub. No.: US 2020/0047520 A1
(43) Pub. Date: Feb. 13, 2020

(54) PRINTING APPARATUS AND PRINTING METHOD

(71) Applicant: CANON KABUSHIKI KAISHA, Tokyo (JP)

(72) Inventors: Ryosuke Sato, Kawasaki-shi (JP); Yusuke Nakaya, Inagi-shi (JP); Takuto Moriguchi, Kamakura-shi (JP)

(21) Appl. No.: 16/527,224

(22) Filed: Jul. 31, 2019

(30) Foreign Application Priority Data
Aug. 7, 2018 (JP) 2018-148720

(51) Int. Cl. B41J 11/00; B41J 2/005

(52) U.S. Cl. CPC B41J 11/002; B41J 2/0057

(57) ABSTRACT

A printing apparatus includes: a print unit configured to discharge ink onto a transfer member and form an ink image; a drying promotion unit configured to promote drying of the ink image on the transfer member; an absorption unit configured to absorb a liquid component from the ink image after drying promotion; and a transfer unit configured to transfer the ink image on the transfer member, whose liquid component is absorbed by the absorption unit, onto a print medium. The drying promotion unit includes: a first heating unit configured to radiate radiant heat to the ink image on the transfer member; and an airflow generating unit configured to generate an airflow flowing in a widthwise direction of the transfer member on the ink image on the transfer member heated by the first heating unit.

### BACKGROUND OF THE INVENTION

### Field of the Invention

The present invention relates to a transfer type printing technique.

### Description of the Related Art

A technique of forming an ink image on a transfer member and transferring it to a print medium such as paper is proposed. For example, Japanese Patent Laid-Open No. 2003-182064 discloses an image forming apparatus configured to form an ink image on an intermediate member and transfer the ink image to a sheet. This apparatus includes an inkjet device that forms a primary image on the intermediate member. This apparatus also includes a zone where an aggregate is formed in the primary image, a zone where a liquid is partially removed from the aggregate, a zone where an image is transferred to a sheet, and a zone where the surface of the intermediate member is reproduced before a new primary image is formed. In addition, Japanese Patent Laid-Open No. 2009-226907 discloses a technique of heating and drying an ink image and then removing part of a liquid from an aggregate of the ink image.

Even when drying of an ink image is promoted by heating for coagulation of the ink image, as disclosed in Japanese Patent Laid-Open No. 2009-226907, if a vapor generated from the ink image remains around the ink image, the drying of the ink image is assumed not to be promoted.

### SUMMARY OF THE INVENTION

The present invention provides a technique of promoting drying of an ink image.

According to an aspect of the present invention, there is provided a printing apparatus comprising: a print unit configured to discharge ink onto a transfer member and form an ink image on the transfer member; a drying promotion unit configured to promote drying of the ink image on the transfer member; an absorption unit configured to absorb a liquid component from the ink image after drying promotion by the drying promotion unit; and a transfer unit configured to transfer the ink image on the transfer member, whose liquid component is absorbed by the absorption unit, onto a print medium, wherein the drying promotion unit comprises: a first heating unit configured to radiate radiant heat to the ink image on the transfer member; and an airflow generating unit configured to generate an airflow flowing in a widthwise direction of the transfer member on the ink image on the transfer member heated by the first heating unit.

Further features of the present invention will become apparent from the following description of exemplary embodiments (with reference to the attached drawings).

### BRIEF DESCRIPTION OF THE DRAWINGS

FIG. 1 is a schematic view showing a printing system;

FIG. 2 is a perspective view showing a print unit;

FIG. 3 is an explanatory view showing a displacement mode of the print unit in FIG. 2;

FIG. 4 is a block diagram showing a control system of the printing system in FIG. 1;

FIG. 5 is a block diagram showing the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 is an explanatory view of peripheral units;

FIG. 9 is an explanatory view of a drying promotion unit;

FIG. 10 is an explanatory view of the drying promotion unit viewed in the direction of an arrow d4 in FIG. 9;

FIG. 11 is a view showing an example of the layer structure of a transfer member;

FIG. 12 is a view showing an example of an upper limit value and a lower limit value for control of the surface temperature of the transfer member;

FIG. 13 is a flowchart showing an example of control;

FIG. 14 is a flowchart showing an example of control;

FIGS. 15A and 15B are explanatory views of drying promotion units according to other examples; and

FIGS. 16A and 16B are explanatory views of drying promotion units according to other examples.

### DESCRIPTION OF THE EMBODIMENTS

Embodiments of the present invention will be described with reference to the accompanying drawings. In each view, arrows X and Y indicate horizontal directions perpendicular to each other. An arrow Z indicates a vertical direction.

<Printing System>

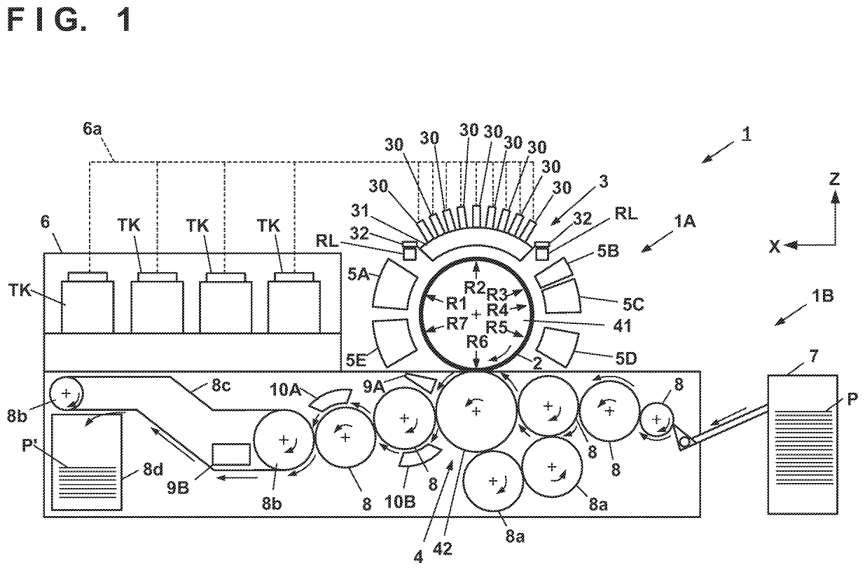

FIG. 1 is a front view schematically showing a printing system (printing apparatus) 1 according to an embodiment of the present invention. The printing system 1 is a sheet inkjet printer that forms (manufactures) a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

Note that “print” includes not only formation of significant information such as a character or graphic pattern but also formation of an image, design, or pattern on print media in a broader sense or processing of print media regardless of whether the information is significant or insignificant or has become obvious to allow human visual perception. In this embodiment, “print media” are assumed to be paper sheets but may be fabrics, plastic films, and the like.

An ink component is not particularly limited. In this embodiment, however, a case is assumed in which aqueous pigment ink that includes a pigment as a coloring material, water, and a resin is used.

<Printing Apparatus>

The printing apparatus 1A includes a print unit 3, a transfer unit 4, peripheral units 5A to 5E, and a supply unit 6.

<Print Unit>

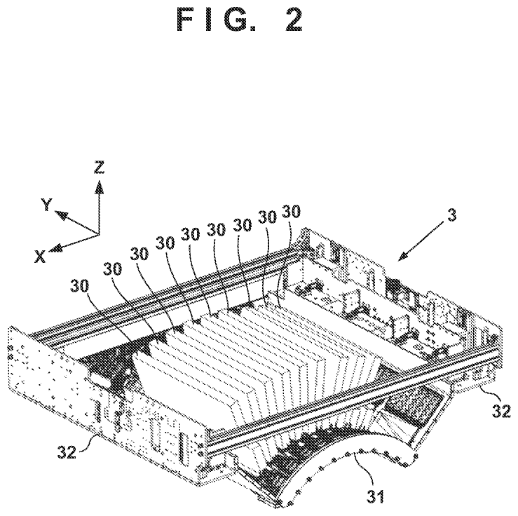

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide member RL. In this embodiment, the guide members RL are rail members elongated in the Y direction and provided as a pair separately in the X direction. A slide portion 32 is provided on each side of the carriage 31 in the X direction. The slide portions 32 engage with the guide members RL and slide along the guide members RL in the Y direction.

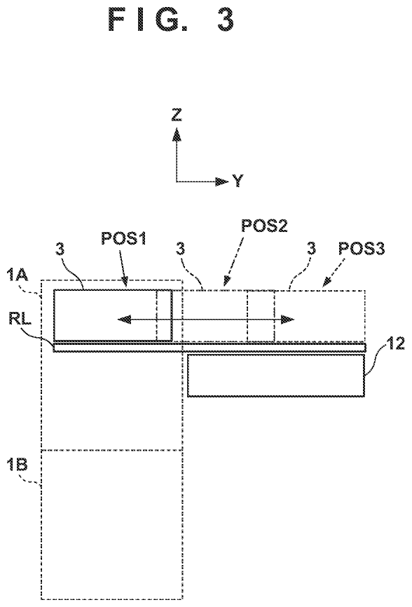

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide member RL is elongated over the recovery unit 12 from the side of the transfer member 2. By the guide of the guide member RL, the print unit 3 is displaceable between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer drum (transfer cylinder) 41 and a pressurizing drum 42. Each of these drums is a rotating body that rotates about a rotation axis in the Y direction and has a columnar outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing area R1 before discharge, a discharge area R2, processing areas R3 to and R5 after discharge, a transfer area R6, and a processing area R7 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 to R5 after discharge are processing areas where processing is performed on the ink image after ink discharge. The processing area R3 after discharge is an area where the peripheral unit 5B performs processing, the processing area R4 after discharge is an area where the peripheral unit 5C performs processing, and the processing area R5 after discharge is an area where the peripheral unit 5D performs processing. The transfer area R6 is an area where the transfer unit 4 transfers the ink image on the transfer member 2 to the print medium P. The processing area R7 after transfer is an area where post processing is performed on the transfer member 2 after transfer and an area where the peripheral unit 5E performs processing.

In this embodiment, the discharge area R2 is an area with a predetermined section. The other areas R1 and R3 to R7 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing areas R3 and R4 after discharge is positioned at almost 2 o'clock, and the processing area R5 after discharge is positioned at almost 4 o'clock. The transfer area R6 is positioned at almost 6 o'clock, and the processing area R7 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer drum 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. At least one grip mechanism which grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer drum 41 and the pressurizing drum 42 can share a driving source such as a motor that drives them, and a driving force can be delivered by a transmission mechanism such as a gear mechanism.

<Peripheral Unit>

The peripheral units 5A to 5E are arranged around the transfer drum 41. In this embodiment, the peripheral units 5A to 5E are specifically an application unit, drying promotion unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The drying promotion unit 5B is a mechanism that promotes drying of an ink image on the transfer member 2 by heating. When drying of the ink image is promoted, coagulation of the ink image is promoted. This can, for example, prevent the ink image from shifting on the transfer member 2 when absorbing the liquid component of the ink image by the absorption unit 5C of the subsequent stage.

The absorption unit 5C is a mechanism that absorbs the liquid component from the ink image on the transfer member 2 before transfer after the drying promotion of the ink image by the drying promotion unit 5B. When the liquid component of the ink image is decreased, bleeding or the like of an image printed on the print medium P can be suppressed. From another viewpoint, the decrease of the liquid component can also be expressed as condensing the ink of the ink image on the transfer member 2. Condensing ink means that the liquid component contained in the ink image decreases, and the content ratio of a solid content such as a coloring material or a resin contained in the ink to the liquid component increases.

The absorption unit 5C includes, in this embodiment, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5D is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5D can use a known heating device, for example, various lamps such as infrared rays, a warm air fan, or the like. An infrared heater can be used in terms of heating efficiency.

The cleaning unit 5E is a mechanism which cleans the transfer member 2 after transfer. The cleaning unit 5E removes ink remaining on the transfer member 2, dust on the transfer member 2, or the like. The cleaning unit 5E can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the drying promotion unit 5B, the absorption unit 5C, the heating unit 5D, and the cleaning unit 5E are included as the peripheral units. However, cooling functions of the transfer member 2 may be applied, or cooling units may be added to these units. In this embodiment, the temperature of the transfer member 2 may be increased by heat of the heating unit 5D. If the ink image exceeds the boiling point of water as a prime solvent of ink after the print unit 3 discharges ink to the transfer member 2, performance of liquid component absorption by the absorption unit 5C may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5E. A cooling timing may be a period before application of the reactive liquid after transfer.

<Supply Unit>

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 8. Each of the conveyance drums 8 and 8a is a rotating body that rotates about the rotation axis in the Y direction and has a columnar outer peripheral surface. At least one grip mechanism which grips the leading edge portion of the print medium P (printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-side printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer drum 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

<Inspection Unit>

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

<Control Unit>

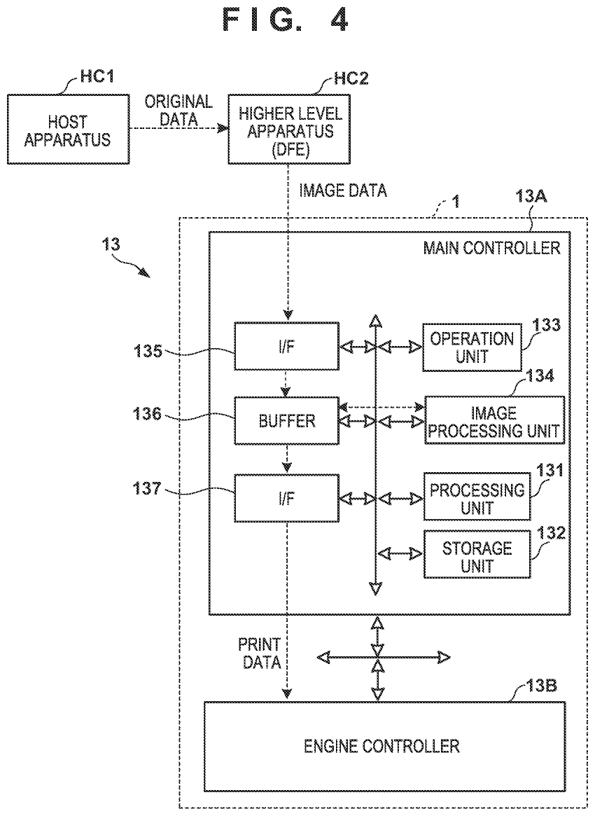

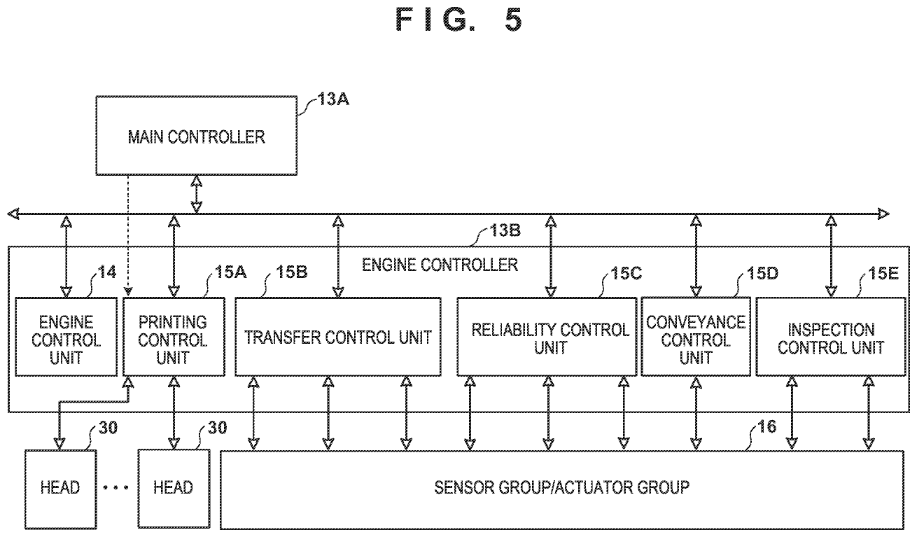

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. The operation unit 133 is, for example, an input device such as a touch panel, a keyboard, or a mouse and accepts a user instruction.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the drying promotion unit 5B, the absorption unit 5C, the heating unit 5D, and the cleaning unit 5E.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

### Operation Example

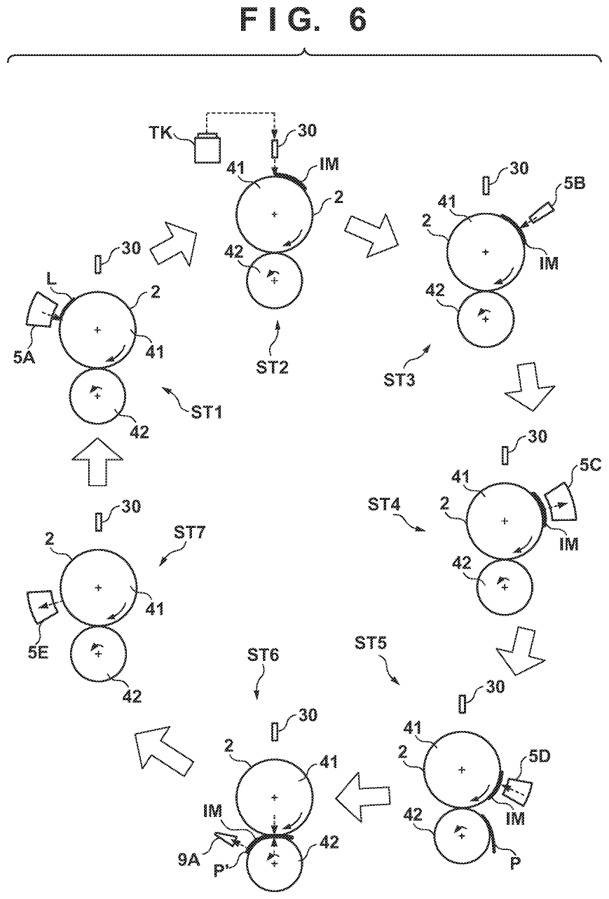

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer drum 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the drying promotion unit 5B, the ink image IM is heated by the drying promotion unit 5B to promote drying, as shown in a state ST3. When the ink image IM reaches the absorption unit 5C, a liquid component is absorbed from the ink image IM by the absorption unit 5C, as shown in a state ST4. When the ink image IM reaches the heating unit 5D, the ink image IM is heated by the heating unit 5D, a resin in the ink image IM melts, and a film of the ink image IM is formed, as shown in a state ST5. In synchronism with such formation of the ink image IM, the conveyance apparatus 1B conveys the print medium P.

As shown in a state ST6, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5E, it is cleaned by the cleaning unit 5E as shown in a state ST7. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

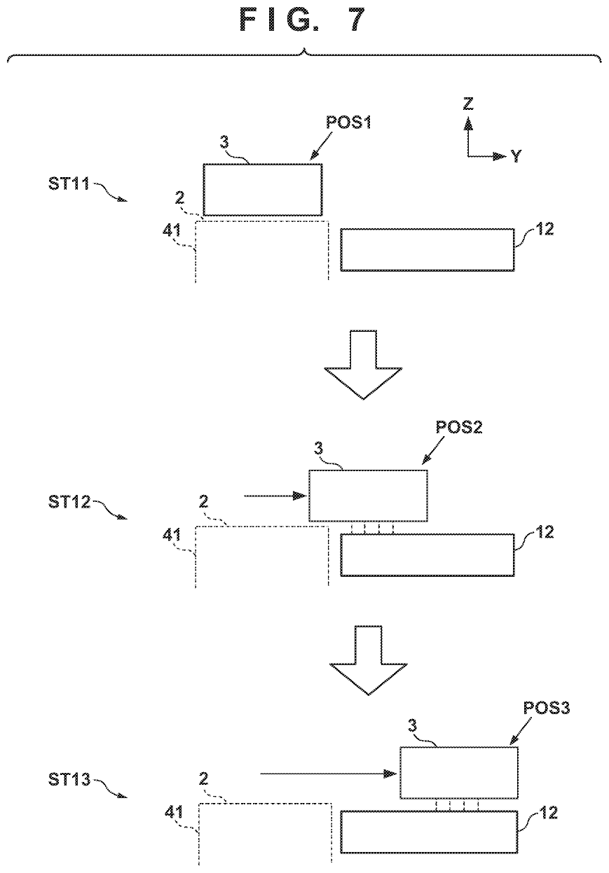

Each printhead 30 needs maintenance if such a printing operation continues. FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

<Details of Peripheral Units>

The drying promotion unit 5B, the absorption unit 5C, and the heating unit 5D will be described in more detail. FIG. 8 is an explanatory view of these. The absorption unit 5C that is located in the middle of the three units will be described first.

The absorption unit 5C is a liquid absorbing apparatus that absorbs a liquid component from the ink image IM formed on the transfer member 2 before the ink image IM is transferred to the print medium P. When the aqueous pigment ink is used as in this embodiment, the absorption unit 5C mainly aims at absorbing water in the ink image. This makes it possible to suppress occurrence of a curl or cockling of the print medium P.

The absorption unit 5C includes a liquid absorbing member 50, a support unit 51 that supports the liquid absorbing member 50 so that it can cyclically move, and a cleaning unit 52.

The liquid absorbing member 50 is an absorber that absorbs the liquid component from the ink image IM at a liquid absorbing position A, and has a form of an endless swath-shaped sheet in the example shown in FIG. 8. An arrow d1 indicates the moving direction of the transfer member 2, and an arrow d2 indicates the moving direction of the liquid absorbing member 50. The liquid absorbing member 50 contacts the ink image IM on the transfer member 2 and absorbs the liquid component of the ink image IM. The ink image IM moves to the heating unit 5D after the liquid component is decreased.

The support unit 51 is a mechanism that supports the liquid absorbing member 50 so that it can cyclically run, and includes a driving rotating body 510, a plurality of driven rotating bodies 511, and a position adjusting mechanism 512. The driving rotating body 510 and the driven rotating bodies 511 are rollers or pulleys on which the swath-shaped liquid absorbing member 50 is wound, and are rotatably supported about axes in the Y direction.

The driving rotating body 510 is rotated by the driving force of a motor M, and causes the liquid absorbing member 50 to run. Note that in this embodiment, the support unit 51 includes the driving rotating body 510. However, this may be omitted, and only the driven rotating bodies 511 may be included. This arrangement makes it possible to press the liquid absorbing member 50 against the transfer member 2 and cause the liquid absorbing member 50 to run using the rotating force of the transfer member 2.

The driven rotating bodies 511 are supported to be freely rotatable. In this embodiment, four driven rotating bodies 511 are provided. The moving path (running track) of the liquid absorbing member 50 is defined by the driven rotating bodies 511 and the driving rotating body 510. The moving path of the liquid absorbing member 50 is a zigzag path bending up/down in the running direction (arrow d2). Accordingly, the longer liquid absorbing member 50 can be used in a smaller space, and the frequency of exchange in a case of performance degradation of the liquid absorbing member 50 can be reduced.

One of the plurality of driven rotating bodies 511 is provided with a tension adjusting mechanism 513. The tension adjusting mechanism 513 is a mechanism that adjusts the tension of the liquid absorbing member 50, and includes a support member 513a, a moving mechanism 513b, and a sensor 513c. The support member 513a supports the driven rotating body 511 rotatably about the axis in the Y direction. The moving mechanism 513b is a mechanism that moves the support member 513a, and is, for example, an electric cylinder. The driven rotating body 511 can be displaced by the moving mechanism 513b, and the tension of the liquid absorbing member 50 is thus adjusted. The sensor 513c is a sensor that detects the tension of the liquid absorbing member 50. In this embodiment, the sensor 513c detects a load received by the moving mechanism 513b. The tension of the liquid absorbing member 50 can automatically be controlled by controlling the moving mechanism 513b based on the detection result of the sensor 513c.

The position adjusting mechanism 512 includes a movable member 512a, a support member 512c, and a pressing mechanism 512b. The movable member 512a is arranged to face the transfer member 2 and, in this embodiment, is a rotating body such as a roller. The movable member 512a is rotatably supported by the support member 512c. The pressing mechanism 512b is a mechanism that moves the movable member 512a to/from the side of the transfer member 2 via the support member 512c, and is, for example, an electric cylinder, but may be an elastic member such as a coil spring. The liquid absorbing member 50 is brought into contact with the transfer member 2 at the liquid absorbing position A by the position adjusting mechanism 512, and absorbs, before transfer, the liquid component from the ink image IM formed on the transfer member 2.

The transfer control unit 15B performs driving control of the motor M. The transfer control unit 15B drives the motor M such that, for example, the liquid absorbing member 50 runs in synchronism with the movement of the transfer member 2. In other words, the motor M is driven such that the circumferential velocity of the surface of the transfer member 2 matches the running speed of the liquid absorbing member 50. This can suppress rubbing of the liquid absorbing member 50 on the coloring materials of the ink image IM.

The cleaning unit 52 is a device that removes dust from the liquid absorbing member 50, and includes a cleaning roller 521, a reserving tank 522, a support member 523, and a moving mechanism 524. The support member 523 supports the cleaning roller 521 rotatably about the axis in the Y direction, and also supports the reserving tank 522. The reserving tank 522 reserves a cleaning liquid 522a, and the cleaning roller 521 is partially dipped in the cleaning liquid 522a. The moving mechanism 524 is a mechanism that moves the support member 523, and is, for example, an electric cylinder. The cleaning roller 521 and the reserving tank 522 also move together with the support member 523. These are moved in the direction of an arrow (here, in the vertical direction) between a cleaning position where the cleaning roller 521 contacts the liquid absorbing member 50 and a retract position where the cleaning roller 521 separates from the liquid absorbing member 50. FIG. 8 shows a state in which the cleaning roller 521 is located at the cleaning position. The cleaning roller 521 may always be located at the cleaning position during the operation of the printing system 1, and may be moved to the retract position at the time of maintenance.

The cleaning roller 521 is arranged to face the driven rotating body 511. At the cleaning position, the liquid absorbing member 50 is nipped by the cleaning roller 521 and the driven rotating body 511. The cleaning roller 521 rotates following the run of the liquid absorbing member 50. The peripheral surface of the cleaning roller 521 is made of, for example, a material with viscosity, and removes dust (paper dust and the like) adhered to the liquid absorbing member 50. For example, rubber such as butyl, silicone, or urethane can be given as a material for the peripheral surface of the cleaning roller 521. The cleaning liquid 522a is, for example, a surfactant, and a liquid that promotes separation of dust adhered to the cleaning roller 521 can be used. The reserving tank 522 may be provided with a wiper that contacts the surface of the cleaning roller 521 and promotes separation of dust.

Note that the absorption unit 5C may be provided with a mechanism that applies a moisturizing liquid to the liquid absorbing member 50 or a mechanism that removes an excess liquid for the liquid absorbing member 50.

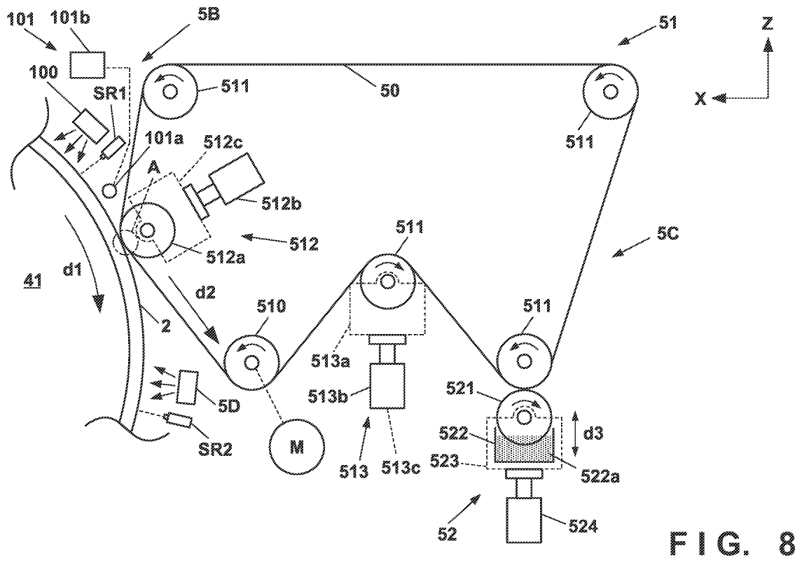

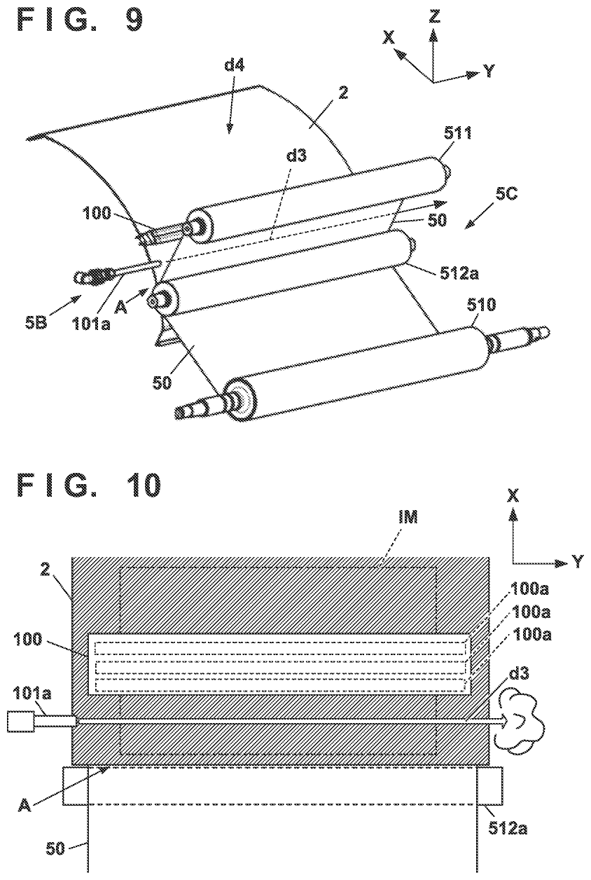

An example of the drying promotion unit 5B will be described next with reference to FIGS. 8 to 10. FIG. 9 is a perspective view showing part of the drying promotion unit 5B and the absorption unit 5C around the liquid absorbing position A, and FIG. 10 is an explanatory view showing part of the drying promotion unit 5B and the absorption unit 5C viewed in the direction of the arrow d4 in FIG. 9.

The drying promotion unit 5B includes a heating unit 100 and an airflow generating unit 101. The heating unit 100 is a mechanism that radiates radiant heat to the ink image IM on the transfer member 2, and is arranged to be spaced apart from the surface of the transfer member 2. Heat generating elements 100a provided in the heating unit 100 are extended in a widthwise direction (Y direction) orthogonal to the moving direction of the transfer member 2. The heat generating element 100a is, for example, a rod-shaped infrared lamp heater and has at least a total length equal to or more than the width of the ink image IM in the Y direction. In a case in which an infrared lamp heater is used as the heat generating element 100a, if the infrared rays are near infrared rays in a wavelength range of, for example, 900 nm to 2,500 nm, the surface temperature of the transfer member 2 can be controlled relatively advantageously.

The transfer member 2 that receives such near infrared rays may include a heat accumulation layer whose surface has a blackish color and in which the absorptance of near infrared rays in the wavelength range of 900 nm to 2,500 nm is 60% or more. FIG. 11 shows an example of the layer structure of the transfer member 2, and shows an example of a three-layer structure including a surface layer 21 that forms the transfer surface, a heat accumulation layer 22, and a heat insulating layer 23.

As the material of the surface layer, various kinds of materials such as a resin and ceramic can appropriately be used, as described above. A material having a high compressive elasticity can be used from the viewpoint of durability. The heat accumulation layer 22 can be a layer also serving as the above-described elastic layer, and, for example, a resin material containing carbon can be used. Accumulation of radiant heat from the heating unit 100 can be promoted by the heat accumulation layer 22. The heat insulating layer 23 can be a layer also serving as the above-described compressed layer, and may be, for example, a layer in which heat insulating properties by air is increased by mixing bubbles. When the transfer member 2 has such a layer structure, the heating efficiency of the transfer member 2 by the heating unit 100 can be increased. That is, the heating efficiency of the ink image IM can be increased.

Referring back to FIGS. 8 to 10, the airflow generating unit 101 is a mechanism that generates, on the ink image on the transfer member 2 heated by the heating unit 100, an airflow flowing in the widthwise direction of the transfer member 2 (the direction (Y direction) orthogonal to the moving direction of the transfer member 2). When the airflow flowing in the widthwise direction of the transfer member 2 is generated, vapor generated by heating the ink image IM can be removed to a side of the ink image IM, and remaining of the vapor around the ink image IM can be suppressed. This can promote the drying of the ink image IM and coagulate the ink image IM.

The airflow generating unit 101 according to this embodiment includes a nozzle 101a that blows a gas, and a supply source 101b that supplies the gas to the nozzle 101a. The supply source 101b is, for example, a compressor. The gas to be blown is, for example, the ambient atmosphere of the printing system 1 and is air at room temperature. When a compressor is used as the supply source 101b, a compressor including an aftercooler can be used. When air is compressed, its temperature rises, and drying is promoted. When the compressed air is cooled by the aftercooler while removing water, more dried air can be blown from the nozzle 101a. This is advantageous in removing vapor around the ink image IM.

The nozzle 101a is arranged at an end of the transfer member 2 in the Y direction. In the example shown in FIG. 10, the distal end of the nozzle 101a overlaps the transfer member 2 when viewed in the radial direction of the transfer member 2. However, an arrangement in which the nozzle 101a does not overlap the transfer member 2 can also be employed. The blowing outlet of the nozzle 101a is spaced outward from the surface of the transfer member 2 in the radial direction of the transfer member 2 (the radial direction of the transfer drum 41). Accordingly, the gas blown from the nozzle 101a is avoided from being directly blown to the ink image IM, and the gas is made to pass above the ink image IM.

The nozzle 101a is oriented in the Y direction, and is arranged such that the blown gas passes through the valley between the transfer member 2 and the liquid absorbing member 50, as indicated by an arrow d3. The oriented direction (blowing direction) of the nozzle 101a is parallel to the Y direction in this embodiment, but may slightly tilt with respect to the Y direction. For example, the nozzle 101a may tilt outward in the radial direction of the transfer member 2. Accordingly, the vapor can be blown off to a side above the ink image IM.

When viewed in the moving direction (circumferential direction of the transfer drum 41) of the transfer member 2, the nozzle 101a is arranged between the heating unit 100 and the liquid absorbing position A of the liquid absorbing member 50. Accordingly, the vapor generated from the ink image IM heated by the radiant heat of the heating unit 100 is efficiently removed by the gas blown from the nozzle 101a before liquid absorption.

An example of control of the drying promotion unit 5B and the heating unit 5D will be described next. In this embodiment, as shown in FIG. 8, temperature sensors SR1 and SR2 that detect a change in the temperature on the transfer member 2 are provided. The temperature sensor SR1 is a sensor that is arranged on the upstream side of the absorption unit 5C and on the downstream side of the heating unit 100 when viewed in the moving direction of the transfer member 2 and detects the surface temperature of the transfer member 2. The temperature sensor SR1 detects a change in the temperature on the transfer member 2 caused by heating of the heating unit 100. The temperature sensor SR2 is a sensor that is arranged on the downstream side of the absorption unit 5C and on the downstream side of the heating unit 5D when viewed in the moving direction of the transfer member 2 and detects the surface temperature of the transfer member 2. The temperature sensor SR2 detects a change in the temperature on the transfer member 2 caused by heating of the heating unit 5D.

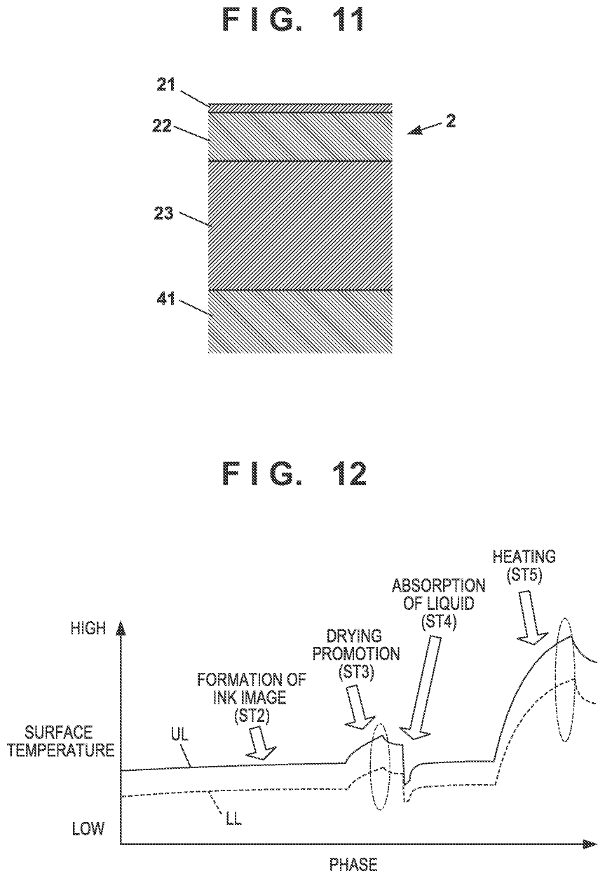

The driving (heat generation amounts) of the heating units 100 and 5D is controlled based on the detection results of the temperature sensors SR1 and SR2, thereby maintaining the surface temperature of the transfer member 2 within a target temperature range. FIG. 12 shows the profile of the surface temperature of the transfer member 2, and shows an upper limit value UL and a lower limit value LL in control. The example of FIG. 12 shows the allowable range of the surface temperature of the transfer member 2 according to the rotation phase of the transfer member 2.

When the stage of formation of the ink image IM (the stage of ST2 in FIG. 6) ends, and the stage of drying promotion by the drying promotion unit 5B (the stage of ST3 in FIG. 6) is reached, the surface temperature of the transfer member 2 is raised by heating of the heating unit 100. The driving of the heating unit 100 is controlled such that the detection result of the temperature sensor SR1 falls within the range between the upper limit value UL and the lower limit value LL.

If the temperature of the aggregate of the ink image IM becomes too high, and an overdried state occurs, the liquid absorption efficiency by the liquid absorbing member 50 lowers at the time of absorption of the liquid component by the absorption unit 5C of the subsequent stage. This is because the viscosity of the ink image IM rises. Ink contains water and a solvent. The water changes to vapor by heating, but the solvent is not dried by heating. For this reason, when the ink image IM is in the overdried state, the viscosity of the ink image IM rises, and the absorptance to the liquid absorbing member 50 lowers. As a result, the residual solvent amount in the ink image IM after transfer to the print medium P is large, and a liquid-rich image is formed. Hence, when the surface temperature of the transfer member 2 is suppressed to the upper limit value UL or less, the overdried state of the ink image IM can be avoided.

In addition, if the temperature of the aggregate of the ink image IM is too low, and an overwet state occurs, the ink image IM may be shifted at the time of absorption of the liquid component by the absorption unit 5C of the subsequent stage. Hence, when the surface temperature of the transfer member 2 is suppressed to the lower limit value LL or more, the overwet state of the ink image IM can also be avoided.

Next, the surface temperature of the transfer member 2 lowers at the stage of absorption of the liquid component of the ink image IM by the liquid absorbing member 50 (the stage of ST4 in FIG. 6), and rises upon heating by the heating unit 5D (the stage of ST5 in FIG. 6). The driving of the heating unit 5D is controlled such that the detection result of the temperature sensor SR2 falls within the range between the upper limit value UL and the lower limit value LL. This can maintain the transferability of the ink image IM to the print medium P.

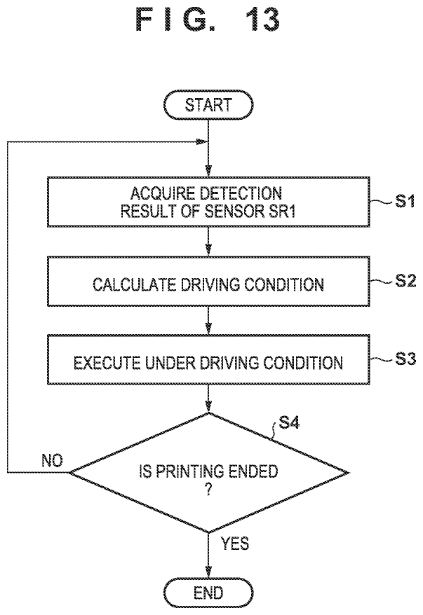

FIG. 13 is a flowchart showing an example of control of the heating unit 100, and shows an example of processing executed by the transfer control unit 15B. In step S1, the detection result of the temperature sensor SR1 is acquired. In step S2, the driving condition of the heating unit 100 is calculated based on the detection result acquired in step S1. For example, the duty ratio of a driving voltage to be supplied to the heating unit 100 is set such that the surface temperature of the transfer member 2 falls within the range between the upper limit value UL and the lower limit value LL described above. In step S3, the heating unit 100 is driven under the driving condition calculated in step S2. In step S4, it is determined whether to end printing. If printing is not to be ended, the process returns to step S1 to repeat the same processing. Note that the end of printing in step S4 means a job of one unit in which an image to be printed and the number of print media P to print are defined, or means from the start to the end of the operation of the system. During the printing operation of the predetermined number of print media P, the heating unit 100 always maintains the surface temperature of the transfer member 2 at the stage of processing of the drying promotion unit 5B within the range between the upper limit value UL and the lower limit value LL by such feedback control.

FIG. 14 is a flowchart showing an example of control of the heating unit 5D, and shows an example of processing executed by the transfer control unit 15B. The control of the heating unit 5D includes two systems. Steps S15 to S17 correspond to feedback control, and steps S12 to S14 include the elements of feedback control and feedforward control.

In step S11, processing of selecting one of the two systems of control is performed. Here, establishment of a predetermined condition is determined. If the predetermined condition is established, the process advances to step S12. If the predetermined condition is not established, the process advances to step S15. The predetermined condition is, for example, a condition of an estimated heat amount needed to maintain the surface temperature of the transfer member 2 at the position of the heating unit 5D within the range between the upper limit value UL and the lower limit value LL. More specifically, for example, it is a condition concerning a change in the ink amount of the ink image IM. If the ink amount (ink ejection amount) of the ink image IM is large, the decrease in the surface temperature of the transfer member 2 becomes large, and the surface temperature difference between the formation portion of the ink image IM and the peripheral portion becomes large, as compared to a case in which the ink amount is small. If the ink amount of the ink image IM switches by a change of an image to be printed, the surface temperature of the transfer member 2 sometimes abruptly changes. To cope with this, control in steps S12 to S14 including the elements of feedback control and feedforward control is executed.

First, in step S12, the detection results of both the temperature sensor SR1 and the temperature sensor SR2 are acquired. In step S13, the driving condition of the heating unit 5D is calculated based on the detection results of the two temperature sensors SR1 and SR2 acquired in step S12. For example, the duty ratio of a driving voltage to be supplied to the heating unit 5D is set such that the surface temperature of the transfer member 2 falls within the range between the upper limit value UL and the lower limit value LL described above. When the detection result of the temperature sensor SR1 is referred to, it is possible to predict the change in the surface temperature of the transfer member 2 and cope with it in advance (feedforward control). For example, a control amount based on the detection result of the temperature sensor SR1 is added (increase the heat generation amount) to or subtracted (decrease the heat generation amount) from a control amount based on the detection result of the temperature sensor SR2. This can cope with an abrupt change in the surface temperature of the transfer member 2 caused by an increase/decrease in the ink amount of the ink image IM.

In step S14, the heating unit 5D is driven under the driving condition calculated in step S13. In step S18, it is determined whether to end printing. If printing is not to be ended, the process returns to step S11 to repeat the same processing.

In step S15, the detection result of the temperature sensor SR2 is acquired. In step S16, the driving condition of the heating unit 5D is calculated based on the detection result acquired in step S15. Here, feedback control is performed by referring to only the detection result of the temperature sensor SR2. For example, the duty ratio of a driving voltage to be supplied to the heating unit 5D is set such that the surface temperature of the transfer member 2 falls within the range between the upper limit value UL and the lower limit value LL described above. In step S17, the heating unit 5D is driven under the driving condition calculated in step S16. After that, the process of step S18 is executed.

As described above, in the control of the heating unit 5D, the detection result of the temperature sensor SR1 located on the upstream side in the moving direction of the transfer member 2 is used as needed, thereby maintaining the surface temperature of the transfer member 2 at an appropriate temperature.

<Other Arrangement Examples of Drying Promotion Unit>

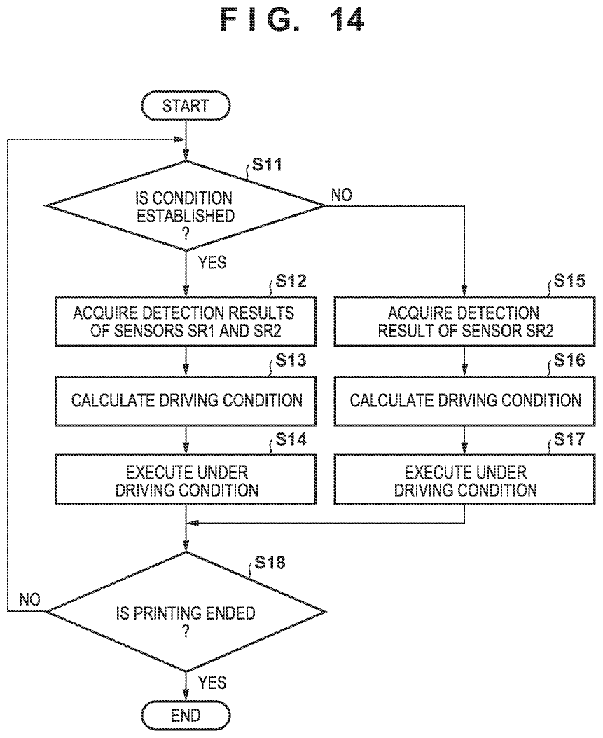

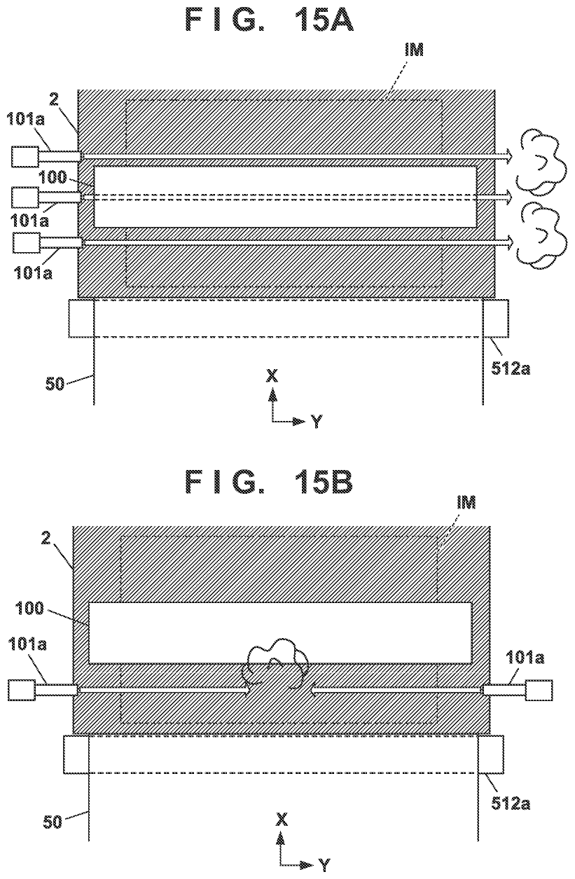

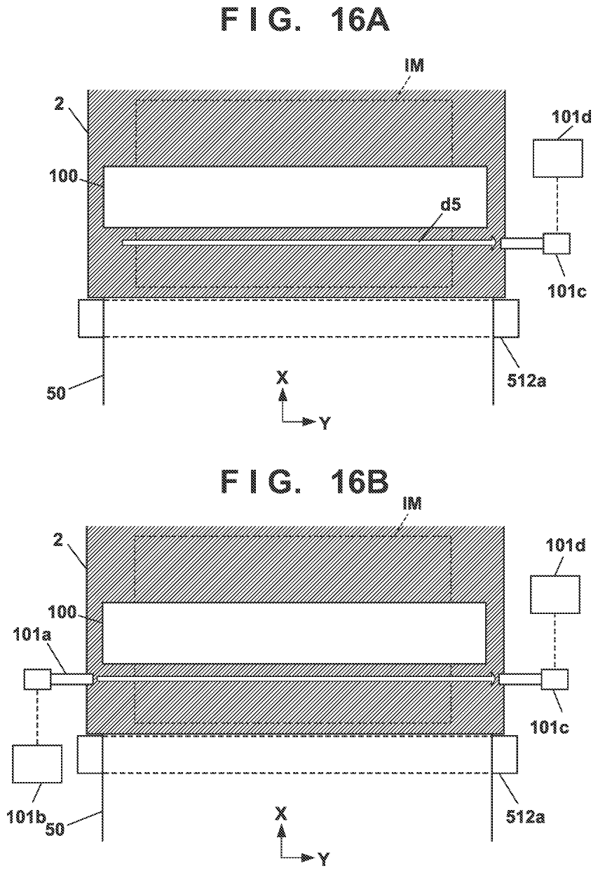

Other arrangement examples of the drying promotion unit 5B will be described with reference to FIGS. 15A to 16B.

In the arrangement example shown in FIG. 15A, the drying promotion unit 5B includes a plurality of nozzles 101a. In the example shown in FIG. 15A, three nozzles 101a are arranged at intervals in the moving direction of the transfer member 2. The gas blowing directions of the nozzles 101a are parallel and are the Y direction. The vapor from the ink image IM can be blown off in a wide range on the transfer member 2.

Additionally, in the example shown in FIG. 15A, the nozzle 101a at the center blows the gas to the space between the heating unit 100 and the surface of the transfer member 2. It is possible to immediately blow off the vapor generated from the ink image IM by the radiant heat of the heating unit 100. Note that all nozzles 101a may blow the gas to the space between the heating unit 100 and the surface of the transfer member 2.

In the arrangement example shown in FIG. 15B, the drying promotion unit 5B includes the nozzle 101a arranged at one end of the transfer member 2 in the Y direction, and the nozzle 101a arranged at the other end of the transfer member 2 in the Y direction. In the example shown in FIG. 15B, the two nozzles 101a are arranged to face each other. The blowing directions of the nozzles 101a may pass by each other, but are set to interfere with each other in the illustrated example. Accordingly, airflows collide against each other at the center of the transfer member 2 in the widthwise direction, the vapor readily rises outward in the radial direction of the transfer drum 41, and the vapor removal efficiency can be improved.

Next, the airflow generating unit 101 may suck the gas on the transfer member 2 in the widthwise direction (Y direction). FIG. 16A shows an example. In the example shown in FIG. 16A, the airflow generating unit 101 includes a suction nozzle 101c arranged at an end of the transfer member 2 in the Y direction, and a negative pressure source 101d such as a pump that sucks the gas via the nozzle 101c. The nozzle 101c is oriented in the Y direction and sucks the gas to generate an airflow in the Y direction, as indicated by an arrow d5. Even in this arrangement, it is possible to suck the vapor around the ink image IM to a side via the nozzle 101c and suppress remaining of the vapor around the ink image IM.

The arrangement example shown in FIG. 16B is a combination of the example shown in FIG. 10 and the example shown in FIG. 16A. In this arrangement example, the blowing nozzle 101a is arranged at one end of the transfer member 2 in the Y direction, and the suction nozzle 101c is arranged at the other end of the transfer member 2 in the Y direction. In the example shown in FIG. 16B, the two nozzles 101a and 101c are arranged to face each other. The blowing directions of the nozzles 101a may pass by each other. However, if the nozzles face each other, as in the illustrated example, a stronger airflow can be generated in the widthwise direction of the transfer member 2. As a result, the vapor around the ink image IM can more efficiently be removed.

### Other Embodiments

In the above embodiment, the transfer member 2 is supported on the transfer drum 41. However, another arrangement can also be employed. For example, like the arrangement of the liquid absorbing member 50 and the support unit 51 shown in FIG. 8, the endless sheet-shaped transfer member 2 may be supported to be cyclically movable by a plurality of rotating bodies.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-148720, filed Aug. 7, 2018, which is hereby incorporated by reference herein in its entirety.

What is claimed is:

1. A printing apparatus comprising:
a print unit configured to discharge ink onto a transfer member and form an ink image on the transfer member;
a drying promotion unit configured to promote drying of the ink image on the transfer member;
an absorption unit configured to absorb a liquid component from the ink image after drying promotion by the drying promotion unit; and
a transfer unit configured to transfer the ink image on the transfer member, whose liquid component is absorbed by the absorption unit, onto a print medium,
wherein the drying promotion unit comprises:
a first heating unit configured to radiate radiant heat to the ink image on the transfer member; and
an airflow generating unit configured to generate an airflow flowing in a widthwise direction of the transfer member on the ink image on the transfer member heated by the first heating unit.

2. The apparatus according to claim 1, wherein the airflow generating unit is configured to generate the airflow by blowing a gas in the widthwise direction.

3. The apparatus according to claim 1, wherein the airflow generating unit is configured to generate the airflow by sucking a gas on the transfer member in the widthwise direction.

4. The apparatus according to claim 1, further comprising:
a first sensor configured to detect a temperature change on the transfer member caused by the first heating unit; and
a control unit configured to control the first heating unit based on a detection result of the first sensor.

5. The apparatus according to claim 1, wherein the first heating unit is configured to radiate infrared rays in a wavelength range of 900 nm to 2,500 nm as the radiant heat, and
the transfer member includes a heat accumulation layer in which an absorptance of the infrared rays in the wavelength range is not less than 60%.

6. The apparatus according to claim 4, further comprising:
a second heating unit configured to radiate radiant heat to the ink image on the transfer member, whose liquid component is absorbed by the absorption unit, before transfer by the transfer unit; and
a second sensor configured to detect a temperature change on the transfer member caused by the second heating unit,
wherein the control unit is configured to control the second heating unit based on the detection results of the first sensor and the second sensor.

7. The apparatus according to claim 1, wherein the airflow generating unit comprises a nozzle arranged at an end of the transfer member in the widthwise direction.

8. The apparatus according to claim 7, wherein the airflow generating unit comprises a nozzle configured to blow a gas, and
the nozzle is oriented in the widthwise direction.

9. The apparatus according to claim 7, wherein the first heating unit is arranged to face the transfer member, and
the airflow generating unit is arranged such that at least part of the airflow passes between the first heating unit and the transfer member.

10. The apparatus according to claim 1, wherein the transfer unit comprises a transfer drum configured to support the transfer member, and
the widthwise direction of the transfer member is a direction parallel to a direction of a rotation axis of the transfer drum.

11. The apparatus according to claim 10, wherein the airflow generating unit comprises a nozzle arranged at an end of the transfer member in the widthwise direction, and
the nozzle is located between the first heating unit and the absorption unit in a circumferential direction of the transfer drum.

12. The apparatus according to claim 1, wherein the widthwise direction of the transfer member is a direction orthogonal to a moving direction of the transfer member.

13. A printing method comprising:
discharging ink onto a transfer member and forming an ink image on the transfer member;
promoting drying of the ink image on the transfer member;
absorbing a liquid component from the ink image after drying promotion in the promoting; and
transferring the ink image on the transfer member, whose liquid component is absorbed in the absorbing, onto a print medium,
wherein the promoting comprises:
radiating radiant heat to the ink image on the transfer member; and
generating an airflow flowing in a widthwise direction of the transfer member on the ink image on the transfer member heated in the radiating.
